(19) United States
(12) Patent Application Publication
(10) Pub. No.: US 2017/0100221 A1
(43) Pub. Date: Apr. 13, 2017

(54) Interdental Cleaning Device

(71) Applicant: Brett Chung, Colorado Springs, CO (US)

(72) Inventor: Brett Chung, Colorado Springs, CO (US)

(21) Appl. No.: 15/118,135

(22) PCT Filed: Feb. 13, 2015
(86) PCT No.: PCT/US15/15862

§ 371 Date: Aug. 11, 2016

(30) Foreign Application Priority Data
Feb. 14, 2014 (JP) 2014-042104

(51) Int. Cl. A61C 15/04

(52) U.S. Cl. CPC A61C 15/043; A61C 2203/00

(57) ABSTRACT

An interdental cleaning device provided with a floss for removing food debris from between the teeth and comprising a case for housing the floss, and a suction cup attached to the case. Accordingly, because the suction cup is provided attached to the case, a user can position the floss on a wall surface position that facilitates easy use of the floss even in an ordinary shower that does not assume the use of the floss therein. In addition, a user can pull out (extract) and utilize only a desired length of the floss from the case with the case in a state of being attached to a wall surface by the suction cup. Hence, a user can pull out (withdraw) and cut the floss with a single hand.

### CROSS-REFERENCE TO RELATED APPLICATIONS

This application claims priority to Japanese Patent App. No. 2014-42104, filed on Feb. 14, 2014 the entire contents of which are incorporated herein by reference as if set forth in full.

### BACKGROUND OF THE INVENTION

Field of the Art

The present invention pertains to an interdental cleaning device (also known as an interproximal dental hygiene device, hereinafter, referred to as interdental cleaning device) for removing food debris that is hard to reach with a toothbrush between teeth and configured with floss housed in a case or dispenser.

Discussion of the State of the Art

A large amount of gum disease (aka gingival and periodontal pathoses) and cavities (aka dental caries) arises from interdental areas. The use of floss, and the like, to remove interdental food debris that cannot be removed effectively with a toothbrush, is imperative for an effective oral health care routine. However, the reality is that the use of floss is not as widespread as toothbrushes and some who use floss may use the same piece or section of floss numerous times for all their teeth.

Typically, floss users generally use floss at a bathroom sink, for example, where they brush their teeth. Often the floss is stored in a drawer and forgotten. When floss is used, plaque and food debris adhere to the floss while it is moved between the teeth and as such, the interdental region cannot be effectively cleaned when the same portion of the floss to which plaque and other debris have adhered is repeatedly, is used for all the teeth. In a sense, all that is being done is the transfer food debris from one interdental location to another.

What is needed is to make the practice of interdental hygiene a habit equivalent to tooth-brushing, (for example, during childhood, i.e. pediatric age group), to facilitate widespread use of floss in order to reduce future incidence of gingival/periodontal pathoses and dental caries by making the practice of flossing more vital and prevalent by proposing a new floss usage style. By making it more convenient for floss to be used in other areas than just the bathroom sink, for example, flossing while a person is taking a shower, the floss may be maintained in a clean state as food debris, and the like, adhered to the floss are continuously rinsed away by the shower, thereby facilitating a more effective and efficient interdental hygiene practice, and the hassle of using floss may be mitigated.

### SUMMARY OF THE INVENTION

Accordingly, the inventor has conceived and reduced to practice, in a preferred embodiment of the invention, a system that promotes a usage style wherein floss may be used in additional environments such as, for example, while taking a shower in a bathroom, or the like.

In a preferred embodiment, because ordinary showers do not assume the use of floss within the shower, a suitable location for placing floss is not provided therein. Hence, when an interdental cleaning device having floss contained in a case is placed, for example, in a soap storage area in a shower, the possibility exist for the interdental cleaning device to easily become slippery (e.g. due to soap), for the interdental cleaning device to easily slip out of and fall from the soap storage area, for soap to easily permeate the floss, and for the interdental cleaning device to hinder the retrieval of the soap.

The instant invention was formed in order to resolve the above-described problems, and an object thereof is to provide an interdental cleaning device that incorporates a mechanism and scheme to somehow improve ergonomics and user-friendliness, and improve and facilitate a flossing habit with floss being used in a new usage style wherein floss may be more conveniently used in additional locations, for example, while showering.

In a first embodiment, a system is provided with floss for removing interdental food debris, a case for housing the floss, a cutter attached to the case for severing the floss to a desired length, and a suction cup attached to the case for suctioning to a wall surface of a location where the floss is to be used.

According to a first embodiment, a case where floss is housed can be attached via a suction cup to a wall surface of a shower or other location where the floss is to be used, and therefore even if the location is an ordinary shower for which the use of floss was not envisioned, a user can easily install floss at a user-friendly position on the wall surface. Hence, compared to conventional interdental cleaning devices that necessitate the placement thereof in a soap storage area, floss may be easily placed in, for example, a shower. Moreover, with respect to users who still prefer to use floss in front of a bathroom sink, the hassle of retrieving a floss case from a cupboard may be eliminated by attaching the case to, for example, a bathroom mirror, wall, or the like, using the suction cup, and a flossing habit may be promoted by maintaining the floss adjacent to or within the user's visual field.

Moreover, with conventional products not provided with a suction cup, the floss is extracted with one hand while the case is held in the other hand, and thus the operation of extracting floss is accomplished with two hands. In contrast, according to the above-described invention, a desired length of floss may be extracted for use from the case while the case in a state of being attached to a wall surface by the suction cup. Accordingly, the hassle of floss use may be mitigated by enabling extraction of floss with one hand, and as a result, the formation of a flossing habit may also facilitated.

In a second embodiment, a mounting part for attaching the suction cup is formed on the case, and the mounting part has a functional capability to adjust a pitch angle of the case with respect to the wall surface by causing the case to rotate while the suction cup is in a state of being suctioned to the wall surface. Accordingly, as illustrated in FIG. 5 (d), the pitch angle of the case may be adjusted according to the user's preference to an angle at which the floss may be easily accessed (i.e. pulled out) from the case, and to an angle at which the floss may be easily severed with the cutter. Moreover, as illustrated in FIG. 5 (a), the pitch angle may be adjusted such that the amount of projection of the case from the wall is minimized when the floss is not being used, thereby enabling storage of the case in a compact state to diminish its interference with other activities, or the like.

In a third embodiment, as floss is severed by pulling on the floss in a state of being hung on the cutter, an optimum direction of the cutter with respect to the direction in which the floss is being pulled is referred to as an optimum cutting direction, and the direction in which the cutter is attached to the case may be set such that the direction of the pitch angle and the optimum cutting direction become parallel. Accordingly, as illustrated in FIG. 5 (a) and FIGS. 7 (a) and (b), when floss is pulled and cut (i.e. extracted) in optimum cutting direction Y1, the direction in which the floss is pulled (i.e. drawn) becomes parallel to the direction of the pitch angle (that is, the direction of the turning diameter when at the prescribed pitch angle). Therefore, in the process of severing the floss, movement of the case (that is, random shifting or drifting) that could alter the pitch angle, may be minimized by the force of pulling (i.e. drawing) on the floss. Namely, surfaces 20a and 20c function as a guide for extracting the floss to minimize movement of the case while the floss is extracted and severed by pulling. Hence, ergonomics in regards to severing the floss may be enhanced because the floss may be cut with the case in a stable state.

In a fourth embodiment, of the case, the cutter is attached to a surface that is vertical with respect to the direction of the central axis of rotation. Here, the cutter is attached to a surface that is parallel to the direction of the central axis of rotation (back surface 20b or front surface 20c illustrated in FIG. 5), some pitch angles may make it challenging for a user standing in front of the device to visualize the cutter 3-dimensionally because the cutter and the surface to which it is attached may appear to be overlapped, which may result in the cut and raised portion of the cutter becoming difficult to distinguish from the surface of attachment, and because the cutter may be physically hidden by the case itself when the device is staged at a certain pitch angle.

Moreover, as illustrated in FIG. 6, when the cutter is a shape that is formed by cutting and raising a portion of metal plate 41, floss is inserted into (i.e. hung on) gap 41a of the cut and raised portion, and the floss is severed by base part 41b of the cut and raised portion, and therefore, when the cutter is arranged with gap 41a oriented in an easy-to-visualize direction, it may become less complicated to insert the floss into gap 41a. However, the cutter is attached to a surface that is parallel to the direction of the central axis of rotation, when the cutter is viewed from a user standing in front of the interdental cleaning device, gap 41a overlaps the cut and raised portion and may be hidden. Moreover, at most pitch angles, gap 41a may be hidden or may not readily visible in this manner. In light of these points, the cutter is attached to a surface that is vertical to the direction of the central axis of rotation (side surface 20a illustrated in FIG. 5), and therefore when the cutter is viewed from a user standing in front of the interdental cleaning device, at most every pitch angle, the cutter may be arranged such that gap 41a does not overlap the cut and raised portion from the user's point of view, and this may lead to enhanced ergonomics during the process of severing the floss. It is more practical and ideal that the cutter is attached to a surface that is exactly vertical to the direction of the central axis of rotation, especially for a cuboidal or cube shaped case. It may be less ideal, but may still be acceptable and functional, to have the cutter attached to a surface in a nearly vertical manner (e.g. 70-110 degrees), especially when the case may not a cuboidal or cube shape, and/or an odd shaped case/object is utilized.

In a fifth embodiment, the interdental cleaning device may be further configured such that the pitch angle is an angle position that becomes a state in which a part of the case may be pressed against the wall surface (hereinafter, referred to as a case pressing position), the case pressing position may be contained within an adjustment range of the pitch angle. Here, it may be assumed that only a desired length of floss may be pulled (i.e. extracted) from the case and severed by the cutter with the case in a state of being attached to a wall surface via the suction cup, and that the extracted and severed floss may, for example, be used in a shower. Accordingly, because the pitch angle may be adjusted such that a part of the case is pressed against the wall surface (the part thereof hereinafter referred to as “pressed part”), if the case is pressed with, for example, a finger, in a direction in which the pressed part is pressed against the wall surface, the case may become fixed at three points, namely, at the pressed part, the suction cup, and, for example, the user's finger. Hence, the case may be secured by merely pressing against it with, for example, a finger with no need to hold the case by, for example, a hand, and thus, for example, if the case is pressed with, for example, the thumb of the dominant hand, and the floss is gripped by, for example, the remaining fingers and severed by the cutter, the floss may be severed with one hand. Accordingly, because floss may be cut with one hand while the case is in a state of being attached to a wall surface, the present invention provides enhanced ergonomics when severing the floss and makes the utilization of floss while showering more practical and user-friendly.

In a sixth embodiment, the position of the mounting part with respect to the case may be set such that when the pitch angle is adjusted to the case pressing position, a part of the case may be pressed against the wall surface via the suction cup. Incidentally, since the surfaces of shower walls are generally made of a slippery material, when the pressed part of the case is pressed directly against the wall surface, the pressed part may slip on the wall surface, and the stability of the case may be compromised. In some cases, the suction cup may peel away from the wall surface. Moreover, if the wall surface is, for example, a mirror, there may be a concern of the pressed part of the case potentially scratching the mirror. With regard to these problems, according to the above-described embodiment, the pressed part is pressed against the wall surface via a suction cup, and therefore, the suction cup acts as a cushion when the case is pressed by, for example, a finger, and the pressed part may not easily slip due to friction with the suction cup. As a result, greater stability of the case may be achieved and the ergonomics of the process of severing the floss is improved.

In a seventh embodiment, at a position where a user of the floss may press against the case with, for example, a finger, an indicator part indicates the position where a part of the case may be pressed against the wall surface by, for example, the user's finger in a state where the angle is adjusted to the case pressing position. Here, the inventor of the present invention may assume a usage method where the pitch angle may be adjusted to the case pressing position, and the floss may be cut while the case is pressed with, for example, a finger, and application or hygiene practice by a user without a proper understanding of this method may be a concern. Moreover, even if a user understands this modality, another concern may be that she may have a difficult time understanding on which part of the case should be pressed, by for example, a finger, in order to more efficiently and effectively cut the floss. In light of these points, according to the above-described embodiment, an indicator part 23 (see in FIG. 3) indicates the position on the case that may be pressed by, for example, a finger, and thus the above-described concerns may be resolved.

In an eighth embodiment, at the position where the user of the floss presses against the case with, for example, a finger, an indicator part indicates the position at which the suction cup is pressed against the wall surface by, for example, the user's finger. Accordingly, when a user severs the floss at a desired length utilizing the cutter attached to the case, a situation where the floss is severed without the case pressed against a wall surface may also be assumed. In other words, when floss is cut in this manner, if indicator part 23a (see FIG. 8) is pressed with, for example, a finger, the case may become pressed against a wall surface via the suction cup. Hence, with the utilization of this floss cutting process, the case may be stably secured, thereby making the floss readily detached or severed. Moreover, if indicator part 23a is pressed by, for example, the thumb of the hand pinching the floss or having the floss wound thereon, the case may be stabilized and the floss may be extracted and severed with one hand, resulting in enhanced ergonomics of the process of severing the floss.

In a ninth embodiment, the mounting part has a function to adjust the rolling angle of the case with respect to the wall surface by causing the case to rotate in an area around the center of rotation (see the dashed and dotted line in FIG. 9 (b)) extending in the vertical direction relative to the wall surface with the suction cup in a state of being suctioned to the wall surface. In this embodiment, a configuration where the cutter may be attached to one of the surfaces on the side of the case may be assumed, and by adjusting the rolling angle (that is, the angle of rotation around the above-described center of rotation), as may be viewed from a user facing the case, the cutter may be positioned on the right side of the case as illustrated in FIG. 9 (b), and the cutter may also be positioned on the left side of the case as illustrated in FIG. 9 (c). Hence, when both a right-handed user and a left-handed user share a single interdental cleaning device (with a single cutter), the cutter may be situated in an optimal position that may simplify the operation of severing the floss without removing the suction cup from the wall surface.

In a tenth embodiment, the case has a lid part to open and close an insertion slot for inserting the floss into the case, and the cutter is attached to the outside of the lid part of the case. According to this invention, because the cutter is attached to the outside of the lid part, the need to open the lid part when severing the floss with the cutter may be eliminated. Hence, the hassle of having to open the lid part when cutting floss may be eliminated.

In an eleventh embodiment, the cutter has a shape formed by cutting and raising a portion of a metal plate, and a protective member is attached to a cut and raised front edge portion of the cutter to, for example, protect the skin of the user from the cutter. Because a usage style where “floss is used while showering” is assumed in a preferred embodiment, when the cutter is positioned on the outside of the lid part, attaching a protective member to the cutter may be extremely important. In light of this point, according to the this embodiment, by attaching a protective member to a front edge portion of the cutter, safety, with respect to the body (for example, fingers and hands) when contacting the cutter when using floss while showering, may be enhanced.

In an twelfth embodiment, a mounting position for the cutter with respect to the case is set such that a distance from the wall surface to the cutter is a prescribed distance or longer with the suction cup in a state of being suctioned to the wall surface. Here, when the floss is pulled out with, for example, the user's fingers and hung on the cutter, the user's fingers must be inserted between the wall surface and the cutter, and therefore if the distance from the wall surface to the cutter is short, the operability of hanging the floss on the cutter may become difficult. Therefore, with the above-described embodiment that takes this point into consideration, the mounting position of the cutter is set such that the distance from the wall surface to the cutter is a prescribed distance or longer, and thus if the prescribed distance is set to a distance that is equivalent to are greater than the thickness of, for example, the finger (for example, 1.5 cm or greater), good operability of hanging the floss on the cutter may be achieved. A prescribed distance of 1.5 cm to 2.5 cm is preferred. Incidentally, if the prescribed distance is excessively large, a value (i.e. rotational moment) obtained by adding the force applied to the cutter when severing the floss with the cutter to the distance from the suction cup to the cutter becomes large, and as a result, the case may easily shift in the direction of the pitch angle. Therefore, the prescribed distance is preferably set to a distance that is not excessively large. More specifically, positioning the cutter on a side closer to the wall than the center position in the longitudinal direction of the case is preferred.

In a thirteenth embodiment, the case has a lid part to open and close an insertion slot for inserting the floss into the case, and may be configured such that a single piece of floss may be pulled out to the exterior of the case from a gap between the case and the lid part, and a guide groove is formed in at least one of either the case or the lid part to guide the floss such that it may be pulled out from the prescribed position. According to this embodiment, floss may always be pulled out from a determined position (i.e. position of the guide groove) of the gap between the case and lid part, and thus the cutting operability of the floss may be improved.

In a fourteenth embodiment, the case has a lid part to open and close an insertion slot for inserting the floss into the case, and a drainage hole for draining water from inside the case is provided in the lid part. Here, as described above, when the floss is not being used, the pitch angle is preferably adjusted such that the amount of projection of the case from the wall is minimized. Hereinafter, this type of angle position is referred to as the storage position. With the present embodiment, which is premised on use in a shower, in a preferred embodiment, there is a high likelihood of water penetrating to the inside of the case. Therefore, in order to drain water from inside the case from the insertion slot, the case is preferably attached to the wall surface such that the insertion slot faces downward in the storage position. However, in this situation, there may be a concern that water drained from the insertion slot could accumulate in the lid part and thereby potentially render the floss unsanitary. In light of this point, a drainage hole is provided in the lid part, and thus when the pitch angle is in a state of being adjusted to the storage position, after water in the case has drained from the insertion slot and reached the lid part, the water is then drained from the drainage hole to the outside of the case. Accordingly, the above-described concern of water accumulating in the lid part may be resolved.

In a fifteenth embodiment, the case has means to retain or store used floss temporarily, and further has a storage space compartment, for example, to hold garbage, with a lid. Accordingly, the case has a mechanism to store used floss until the storage holding compartment becomes full, or temporarily, or for a medium or long term according to the user's style or preference.

Note that with a sixteenth embodiment, a cutter for severing floss to a desired length is attached to the case, and the case has a holding means to retain used floss that has been severed by the cutter on the outside of the case. According to this embodiment, used floss may be temporarily held, and thus there is no need to provide a garbage can for discarding used floss in the shower, and wasted space in the shower may be eliminated.

Moreover, with each of the above-described embodiments, in order to improve the habit of flossing, the addition of the arrangements listed below may be preferable.
1. The floss may be mounted in a position that is easy to see and easy to use.
2. Regardless of age, even young children or the elderly may be able to cut the floss string safely with one hand.
3. Adorable characters of animals or other living things may be used to promote enjoyment and daily use by both male and female users of all ages including the elderly and young children (see FIGS. 12 and 13).
4. The shape thereof is not limited to only adorable characters, and designs may also be provided that possess both functionality and storage space for used floss (see FIGS. 12 and 13).

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a perspective view of an interdental cleaning device according to a preferred embodiment of the invention.

FIG. 2 is a diagram showing a state in which the interdental cleaning device is in the storage position and a state during which floss is cut according to the preferred embodiment of the invention.

FIG. 3 is a diagram explaining the procedures or process for cutting floss according to a preferred embodiment of the invention.

FIG. 4 is a perspective view of showing an interdental cleaning device according to a preferred embodiment of the invention.

FIG. 5 is a diagram showing the device in the storage position, a state during which floss is hung, and a state in which floss is cut according to the preferred embodiment of the invention.

FIG. 6 is a diagram showing a shape of the cutter.

FIG. 7 is a diagram illustrating examples of different configurations of the floss cutting according to the preferred embodiment of the invention.

FIG. 8 is a diagram showing an interdental cleaning device according to a preferred embodiment of the invention.

FIG. 9 is a diagram showing an interdental cleaning device according to a preferred embodiment of the invention.

FIG. 10 is a diagram showing an interdental cleaning device according to another embodiment of the invention.

FIG. 11 is a diagram showing an interdental cleaning device according to another embodiment of the invention.

FIG. 12 is a diagram showing an application embodiment of an interdental cleaning device that uses an animal character (for example, a turtle) and simultaneously provides a means for storing used floss.

FIG. 13 is a diagram showing an exemplary application of an interdental cleaning device that uses an animal character (for example, a turtle) and simultaneously provides a means for storing used floss.

### LIST OF REFERENCE NUMERALS

With regard to reference numerals used, the following numbering is used throughout the drawings:
10 floss
11 bobbin
20 case
21 insertion slot
23 indicator part
40 cutter
42 front edge portion
43 protective sheet (protective member)
50 outer lid (lid part)
51 drainage hole
53 guide groove
60 holding projection (holding means)
70 mounting part
80 suction cup
Y1 optimum cutting direction
W wall surface

### DETAILED DESCRIPTION

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structure and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Embodiments that give form to the interdental cleaning device according to the present invention are described below based on the drawings.

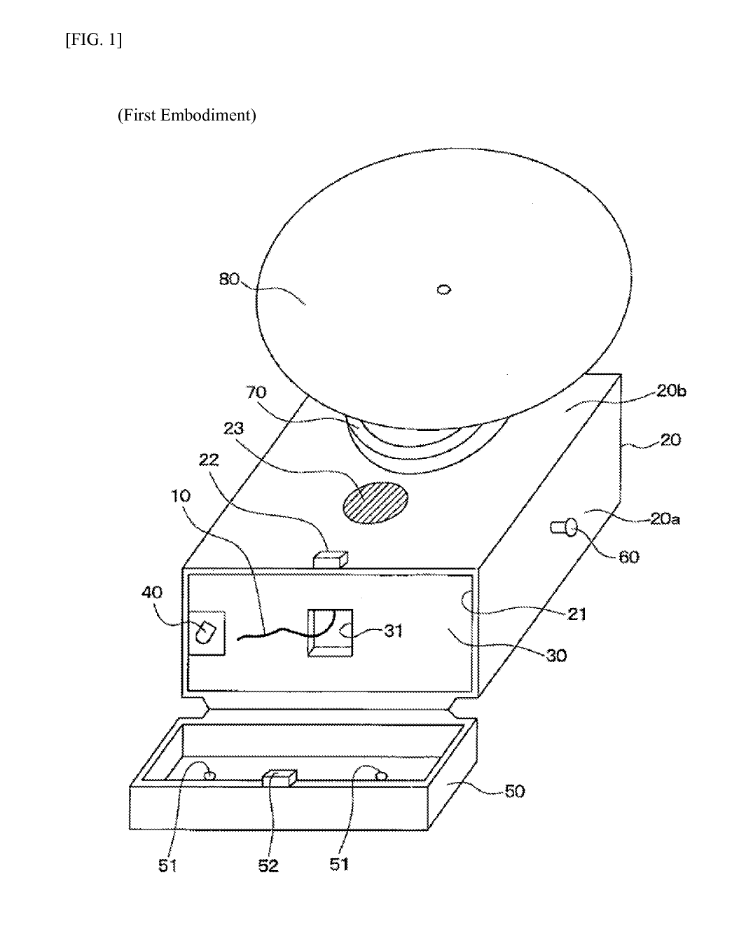

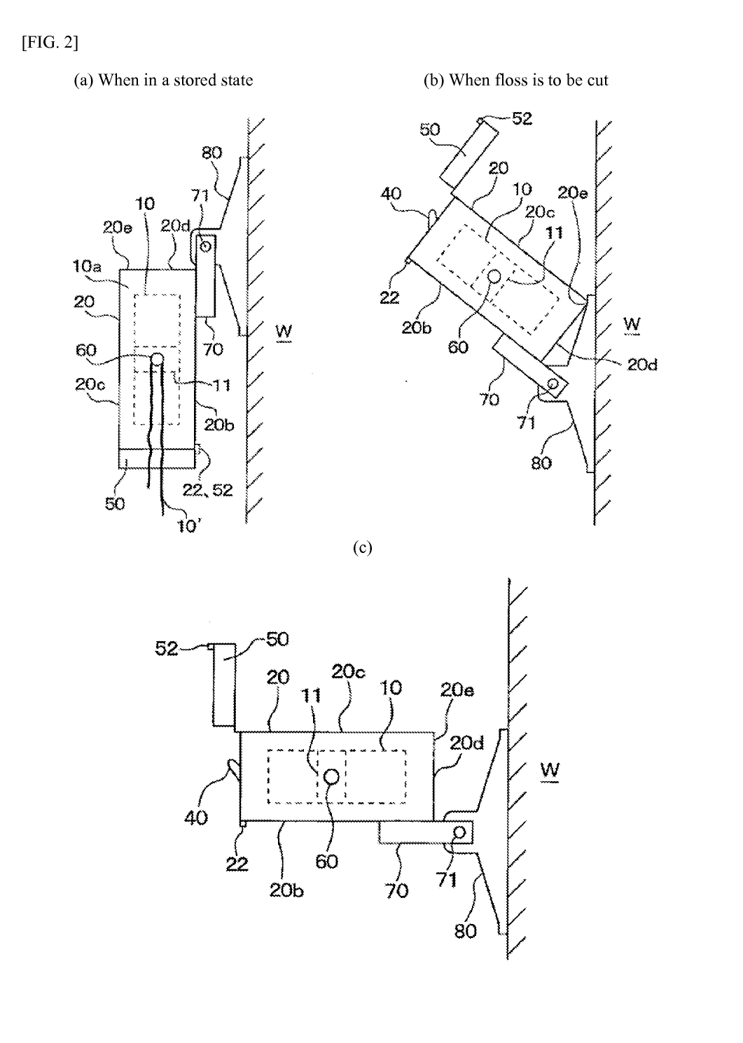

FIG. 1 is a perspective view showing an interdental cleaning device, wherein the interdental cleaning device is provided and configured with floss 10, case 20, inner lid 30, cutter 40, outer lid (lid part) 50, holding projection 60 (holding means), mounting part 70, and suction cup 80, which are hereinafter described. Floss 10, for example, is configured by bundling a plurality of fibers of nylon, polyester, polypropylene, or the like. Floss 10 is housed in case 20 in a state of being wound around bobbin 11 (see FIG. 2). Incidentally, bobbin 11 is a cylindrical shape extending in the right and left directions of FIG. 2 (a), and floss 10 is wound around the cylindrical outer circumference surface thereof. Case 20 is formed from a synthetic resin in a rectangular parallelepiped shape. Floss 10 in a state of being wound on bobbin 11 is inserted and arranged inside case 20 from insertion slot 21 of case 20, and insertion slot 21 is blocked off by inner lid 30. In this manner, floss 10 housed in case 20 can be pulled out from extraction slot 31 formed in inner lid 30 (see FIG. 1). Moreover, floss 10 is severed to a desired length by cutter 40 attached to inner lid 30, and then the cut floss may be utilized by a user to, for example, clean between teeth. Outer lid 50 that covers extraction slot 31 and cutter 40 is attached to case 20. Drainage hole 51 for draining water from inside case 20 is formed in outer lid 50, and when outer lid 50 is in a shut state, engaging part 52 of outer lid 50 mates with engaging part 22 of case 20 to retain outer lid 50. Moreover, mounting part 70 having rotating shaft 71 is provided on case 20, and suction cup 80 is attached to rotating shaft 71. Accordingly, with suction cup 80 in a state of being suctioned to a wall surface, case 20 may rotate around rotating shaft 71. Note that the friction generated between rotating shaft 71 and mounting part 70 is set such that case 20 may not rotate under its own weight. For example, even if in a state of FIGS. 2 (b) and (c) to be hereinafter described, case 20 does not rotate under its own weight.

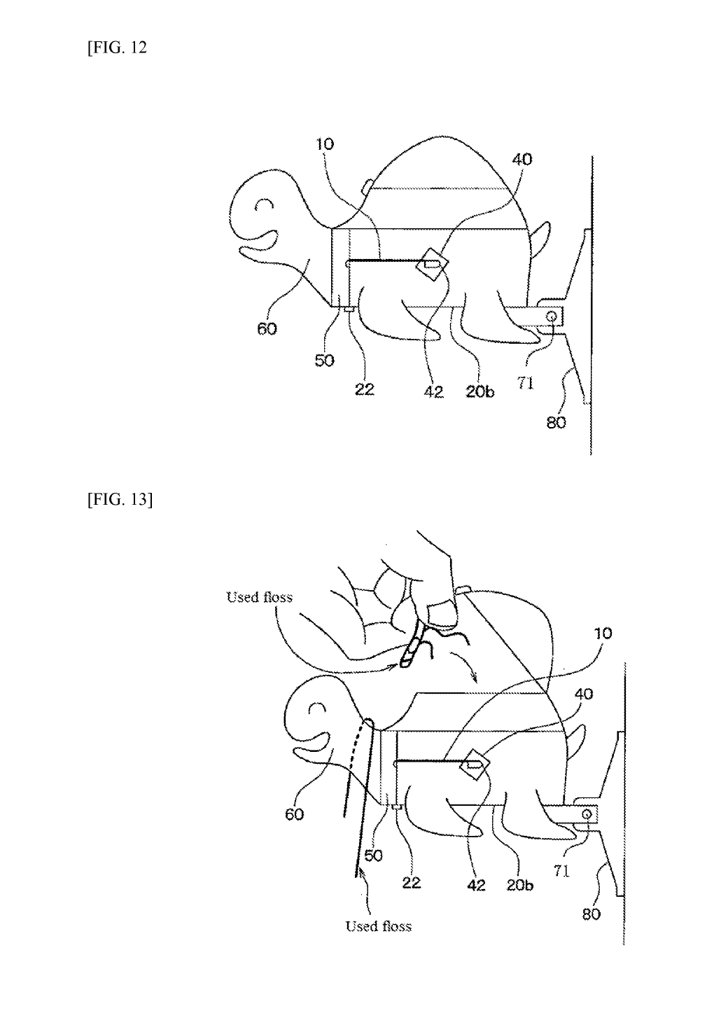

The interdental cleaning device according to the present embodiment assumes, in a preferred embodiment, a usage style wherein “floss is used while showering in a shower of a bathroom or the like,” and as shown in FIG. 2, assumes that suction cup 80 is suctioned to wall surface W of a shower. FIG. 2 (a) is a diagram showing case 20 in the stored state, FIG. 2 (b) is a diagram showing a usage state when floss 10 is to be severed by cutter 40, and FIG. 2 (c) is a diagram showing a state in which the pitch angle of case 20 with respect to wall surface W is adjusted to approximately 90 degrees. Incidentally, the pitch angle when case 20 is in the stored state is approximately 0 degrees, and the pitch angle when the floss is to be cut is 125 to 145 degrees. Moreover, if the interdental cleaning device is used such that outer lid 50 is positioned to the bottom of case 20 when case 20 is in the stored state, when outer lid 50 is in an opened state, water inside case 20 drains from insertion slot 21 or extraction slot 31, and when outer lid 50 is in a closed state, the water thereof drains from drainage hole 51. Water that has accumulated inside outer lid 50 when in a stored state is drained from drainage hole 51, and drainage hole 51 may be particularly effective for this function. Case 20 is formed in a rectangular parallelepiped shape, and the “thickness” dimension, which is the dimension in the axial direction (that is, right and left direction) of FIG. 2 (a)) of bobbin 11 of case 20, is set shorter compared to the radial direction of bobbin 11 of case 20, or in other words, compared to the “length” dimension (that is, up and down direction of FIG. 2 (a)), which is the direction perpendicular to the axial direction, and to the “width” dimension (that is, vertical direction of the paper surface of FIG. 2 (a)), and when case 20 is in stored away, storage such that the radial direction becomes parallel with wall surface W is assumed. In the description below, of case 20, the surface positioned laterally in the stored state is lateral surface 20a, the surface facing the wall is back surface 20b, the surface on the side opposite the back surface 20b is front surface 20c, and the surface on the side opposite the outer lid 50 is top surface 20d. Mounting part 70 is attached to back surface 20b at a position near top surface 20d. In this manner, rotating shaft 71 is positioned further upward than top surface 20d. Holding projection 60 is attached to lateral surface 20a, and through this, used floss 10 is hung on holding projection 60, and may be temporarily held thereon (see FIG. 2 (a)). Moreover, because holding projection 60 is attached to lateral surface 20a, used floss 10 does not easily come off and potentially fall from holding projection 60 when case 20 is rotated. In the application examples of FIGS. 12 and 13, the neck, limbs, and tail of the turtle serve as holding projections 60. Next, the procedure for severing the floss 10 to a desired length using cutter 40 is explained. As described above, the interdental cleaning device is configured such that of the pitch angle, when an angle position (that is, position of FIG. 2 (b)) that becomes a state in which a part of case 20 is pressed against wall surface W is called the case pressing position, the case pressing position is contained within an adjustment range of the pitch angle. Basically, case 20 can rotate as far as a position at which the corner (i.e. pressed part 20e) of top surface 20d on front surface 20c side is pressed against wall surface W. Moreover, the position of mounting part 70 is adjusted such that when the unit is rotated to the case pressing position, pressed part 20e is pressed against wall surface W via the suction cup 80 (see FIG. 2 (b)).

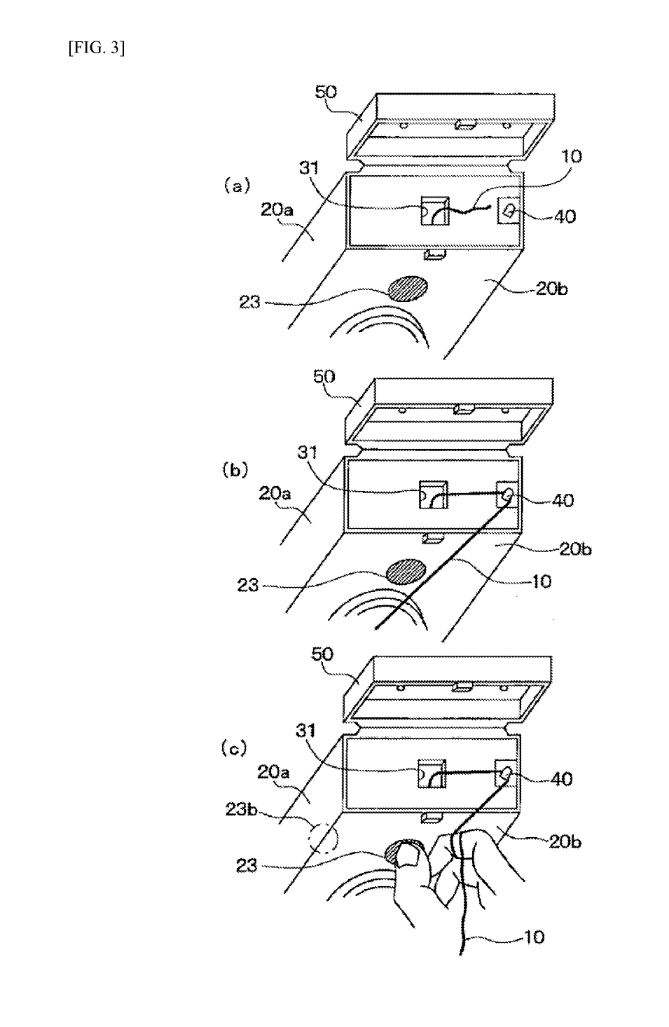

When cutting floss 10, first case 20 is rotated to the above-described case pressing position. Next, outer lid 50 is opened (see FIG. 3 (a)), and then the tip of floss 10 protruding from extraction slot 31 is gripped via the fingers, and floss 10 is hung on cutter 40 (see FIG. 3 (b)). Next, back surface 20b is pressed with, for example, any finger (for example, the thumb is shown in the example of FIG. 3) of the hand gripping floss 10 (for example, the right hand is shown in the example of FIG. 3). In this manner, pressed part 20e is pressed against wall surface W. As a result, case 20 is supported at three points including suction cup 80, pressed part 20e, and the thumb, and is thereby made stable.

Note that indicator part 23 that prompts the user to press the case with, for example, a finger is provided on back surface 20b of case 20. Indicator part 23 may be, for example, a printed indicator, an indicator formed as an irregular surface portion in case 20, or an indicator formed by attaching a separate material to case 20. Moreover, indicator part 23 is provided on back surface 20b at a position that is optimal for stabilizing case 20, the position thereof also being favorable for providing good cutting operability. Accordingly, suction cup 80 is provided on case 20, and therefore, even with an ordinary shower that does not assume the use of floss 10, a user can reach floss 10 from a user-friendly position on the wall surface. Moreover, with case 20 in a state of being attached to wall surface W with suction cup 80, the user can extract and use a desired length of floss 10 from case 20. Accordingly, a user may pull out and cut floss 10 with a single hand. Moreover, in addition to having a function to adjust the pitch angle of case 20, the interdental cleaning device is configured such that case 20 does not rotate under its own weight, and therefore the unit may be adjusted to a pitch angle that makes it easy to pull out floss 10 from extraction slot 31. Moreover, by adjusting the pitch angle, the unit may be positioned in a stored state with back surface 20b facing wall surface W, and thus when floss 10 is not being used, the amount of projection of case 20 from wall surface W may be minimized such that case 20 does not interfere with other activities, or the like. Moreover, because the pitch angle may be adjusted such that a part (pressed part 20e) of case 20 is pressed against wall surface W, floss 10 may be severed by cutter 40 with case 20 in a state of being secured at three points including pressed part 20e, suction cup 80, and, for example, a finger, and as a result, floss 10 may be stably cut using a single hand. In addition, because the pitch angle is set such that pressed part 20e is pressed against wall surface W via suction cup 80, when indicator part 23 of case 20 is pressed by, for example, a finger, pressed part 20e does not easily slip due to friction with suction cup 80. Hence, the stability of case 20 when cutting floss may be enhanced. Moreover, because suction cup 80 is interposed between pressed part 20e and wall surface W, when case 20 is pressed against wall surface W, scratching of wall surface W by the pressed part 20e may be prevented. If wall surface W is, for example, a mirror, the configuration thereof protects against scratching of the mirror, and is therefore favorable. Because drainage hole 51 is provided on outer lid 50, accumulation of water on the inside of outer lid 50 when the unit is in a stored state may be prevented, and thus, for example, mildew prevention and other sanitary measures may be improved. Moreover, because holding projection 60 is provided on case 20, when a user is bathing, the user can temporarily store used floss 10, and there is no need to provide a bulky garbage can for discarding floss in the shower.

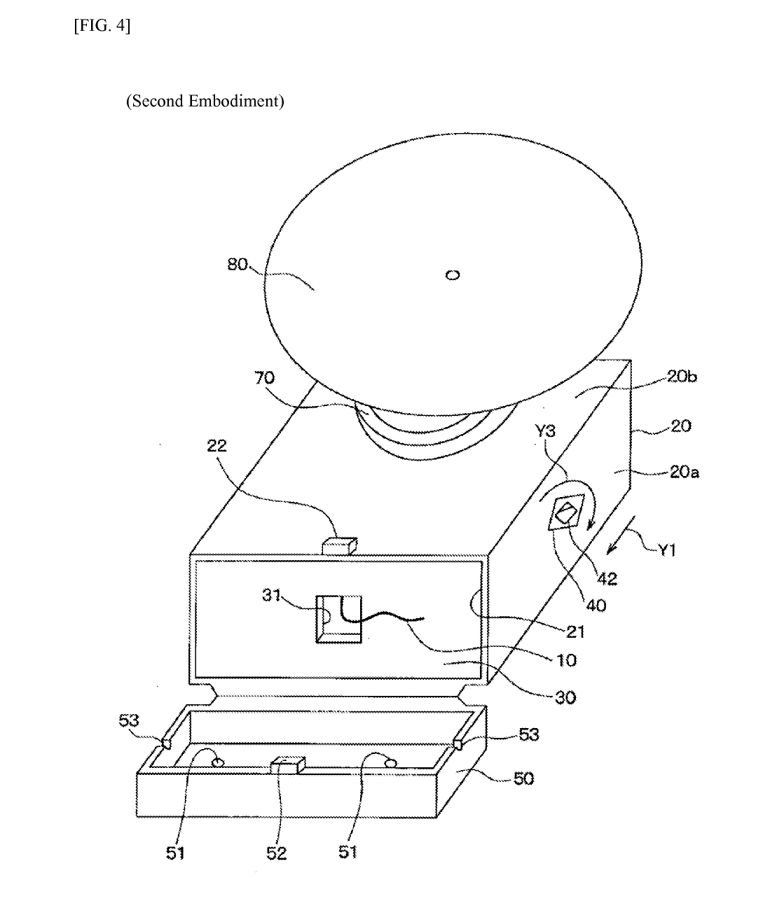

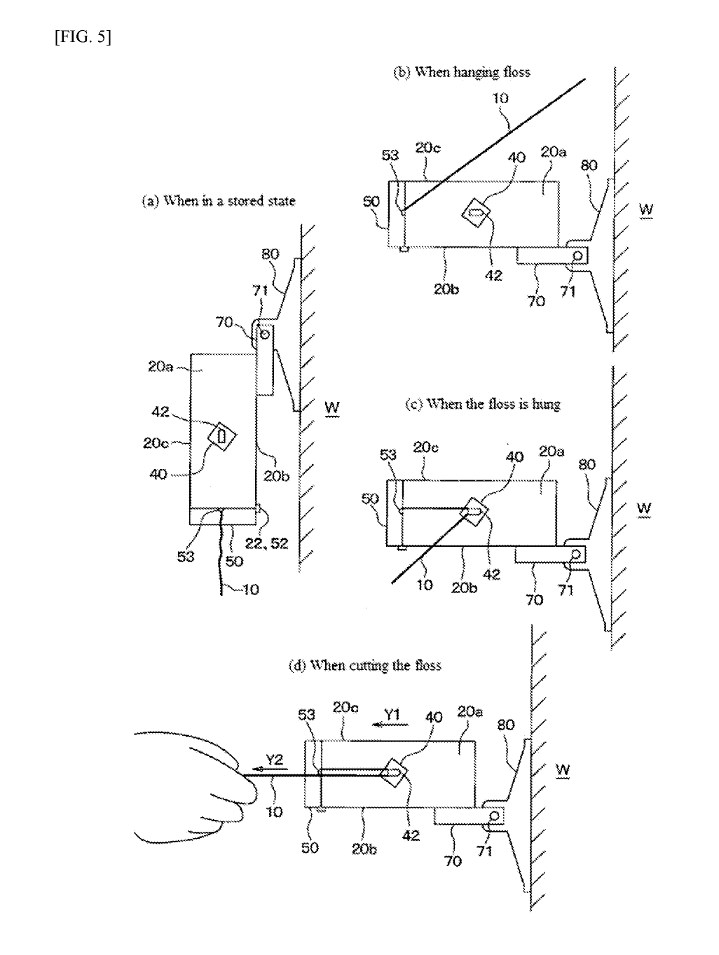

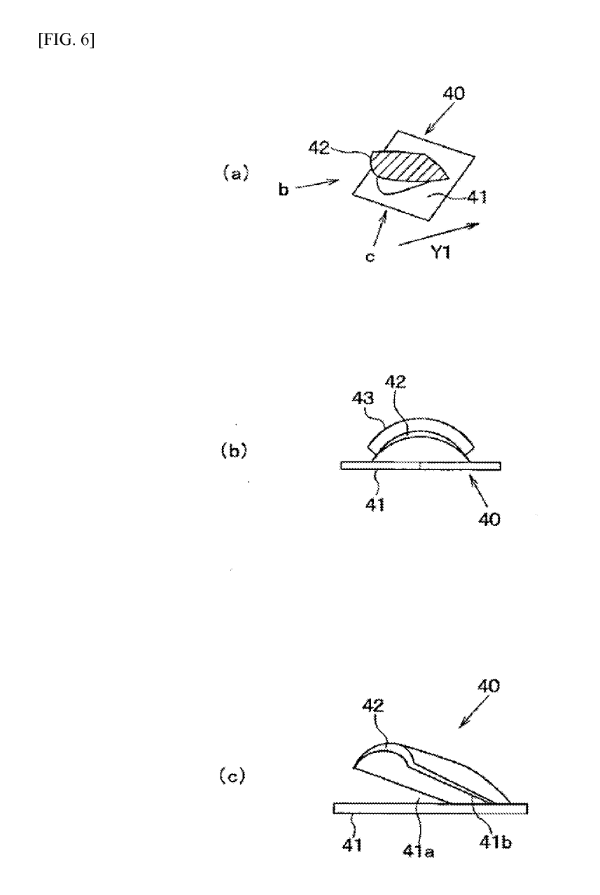

In contrast to the above-described embodiment in which cutter 40 is positioned on the inside of outer lid 50, in this embodiment, as shown in FIG. 4, cutter 40 is positioned on side surface 20a of case 20, side surface 20a being an outer surface positioned on the outside of outer lid 50 of case 20. Note that in the present embodiment, cutter 40 is attached to both side surfaces 20a. Holding projection 60 is provided in a position that does not interfere with cutter 40 (see application examples of FIGS. 12 and 13, wherein the neck, limbs, and tail function as holding projections 60). Moreover, as shown in FIG. 5, the interdental cleaning device is configured such that a single piece of floss 10 is pulled to the outside of outer lid 50 from the gap between case 20 and outer lid 50 with outer lid 50 being in a closed state. FIG. 5 (a) is a diagram showing a state in which the device is in a stored state according to the present embodiment, FIGS. 5 (b) and (c) are diagrams showing a state in which floss 10 is hung on gap 41a (see FIG. 6 (c)) of cutter 40, and FIG. 5 (d) is a diagram showing a state in which floss 10 is severed by cutter 40. Guide groove 53 is formed in outer lid 50 to guide floss 10 such that it is pulled out from the prescribed position. Specifically, guide groove 53 is formed at a place in outer lid 50 adjacent to side surface 20a.

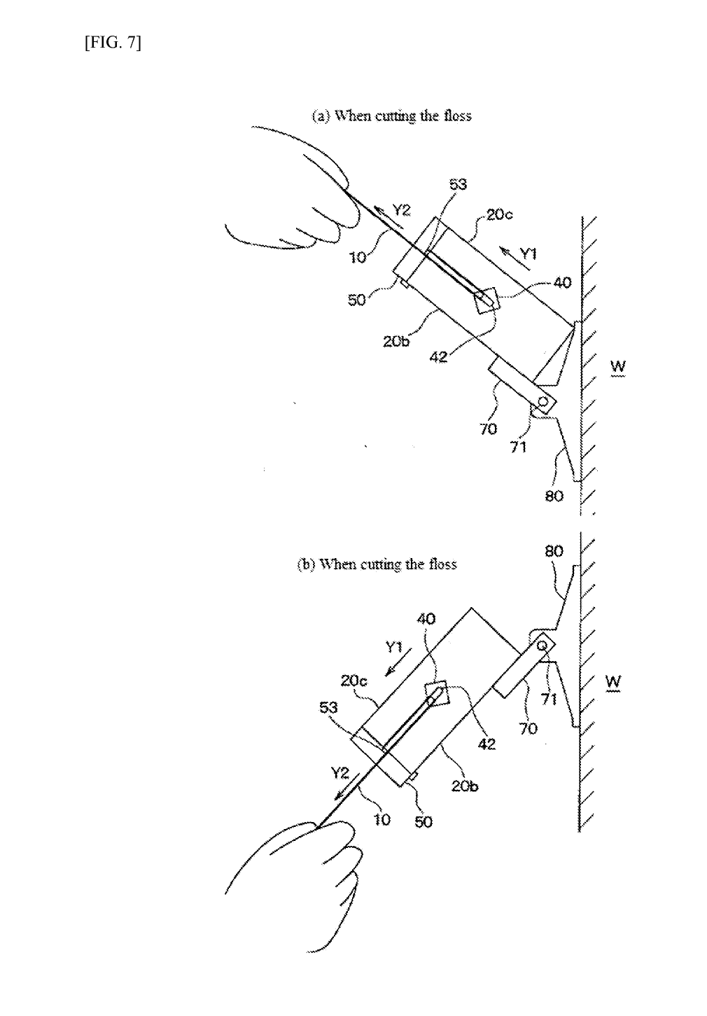

FIG. 6 (a) is a perspective view used to explain the structure of cutter 40, and as illustrated, cutter 40 is a shape that is formed by cutting and raising a portion of metal plate 41. The portion having diagonal lines added in the figure is the cut and raised portion. This type of cutter 40 can sever floss 10 with little pulling force when floss 10 is pulled in the cut and raised direction (direction shown by arrow Y1). Hereinafter, Y1 direction is referred to as the “optimum cutting direction”. Further, the direction at which cutter 40 is attached to case 20 is set such that the direction of the pitch angle (a 90 degree direction in the example of FIG. 5 (d)) matches optimum cutting direction Y1. In other words, when floss 10 is pulled and cut in optimum cutting direction Y1, direction Y2 in which floss 10 is pulled matches the direction of the pitch angle. Incidentally, when floss 10 is cut with the pitch angle in a state of approximately 135 degrees as shown in FIG. 7 (a), the angle of the optimum cutting direction Y1 with respect to wall surface W is also 135 degrees. Moreover, when floss 10 is cut with the pitch angle in a state of approximately 45 degree as shown in FIG. 7 (b), the angle of optimum cutting direction Y1 with respect to wall surface W is also 45 degrees.

FIG. 6 (b) is an auxiliary view along arrow b of FIG. 6 (a), and protective sheet 43 (protective member) made of a material (for example, synthetic resin, rubber, silicone, or the like) with lower hardness (that is, lower modulus of elasticity) than metal plate 41 is attached to front edge portion 42 of the cut and raised portion shown by the diagonal lines in FIG. 6 (a). Through this, when floss 10 is used while showering, safety performance with respect to, for example, contact of the user's body with front edge portion 42 of cutter 40 may be improved. Note that protective sheet 43 may also be a shape that covers the entire cut and raised portion, and must, at the very least, be a shape that covers front edge portion 42.

FIG. 6 (c) is an auxiliary view along arrow c of FIG. 6 (a), and when floss 10 inserted in gap 41a of the cut and raised portion is pulled in optimum cutting direction Y1, the floss is cut by base part 41b of the cut and raised portion. Moreover, the mounting position of cutter 40 with respect to case 20 is set such that the distance from wall surface W to cutter 40 is a prescribed distance or longer, and by setting the prescribed distance such that it is equivalent to or greater than the thickness of a finger, the ergonomics of hanging floss 10 on cutter 40 may be enhanced. Through the above, according to the present embodiment, because cutter 40 is positioned outside of outer lid 50, the floss may be cut without opening outer lid 50. Moreover, floss 10 is always pulled out (i.e. introduced) from a determined optimum position due to the formation of guide groove 53, and hence the ergonomics of severing floss 10 may be enhanced. Furthermore, because floss 10 is pulled out (i.e. introduced) from guide groove 53 and cut with outer lid 50 in a closed state, the leading tip portion of severed floss 10 is positioned on the outside of outer lid 50 and is in a state of dangling from case 20 (see FIG. 5 (a)), or the leading tip portion of severed floss 10 is in a state of hanging on cutter 40. Therefore, the next time that floss 10 is to be pulled out (i.e. withdrawn) from case 20 to a desired length, the user can grip and pull out floss 10 dangling from case 20 (or hanging on cutter 40) without opening outer lid 50. Moreover, when floss 10 is pulled and severed in optimum cutting direction Y1, direction Y2 in which the floss is pulled matches the direction of the pitch angle. In other words, floss 10 is pulled in a direction that is parallel to side surface 20a. Therefore, in the process of severing floss 10, movement (i.e. drifting) of case 20 that may result from changing the pitch angle may be minimized by the force of pulling on floss 10. Accordingly, floss 10 may be cut with case 20 in a stable state, and therefore the ergonomics of cutting the floss thereof may be enhanced. Namely, case 20 may be stabilized such that it does not shift (i.e. drift) in position even if a user adjusts case 20 to a preferred pitch angle and pulls and cuts the floss at that preferred pitch angle. Furthermore, because cutter 40 is attached to side surface 20a, gap 41a of cutter 40 may become easily visible by a user standing in front of case 20. Hence, the ergonomics of hanging floss 10 on cutter 40 may be enhanced compared to the attachment of cutter 40 to front surface 20c or back surface 20b.

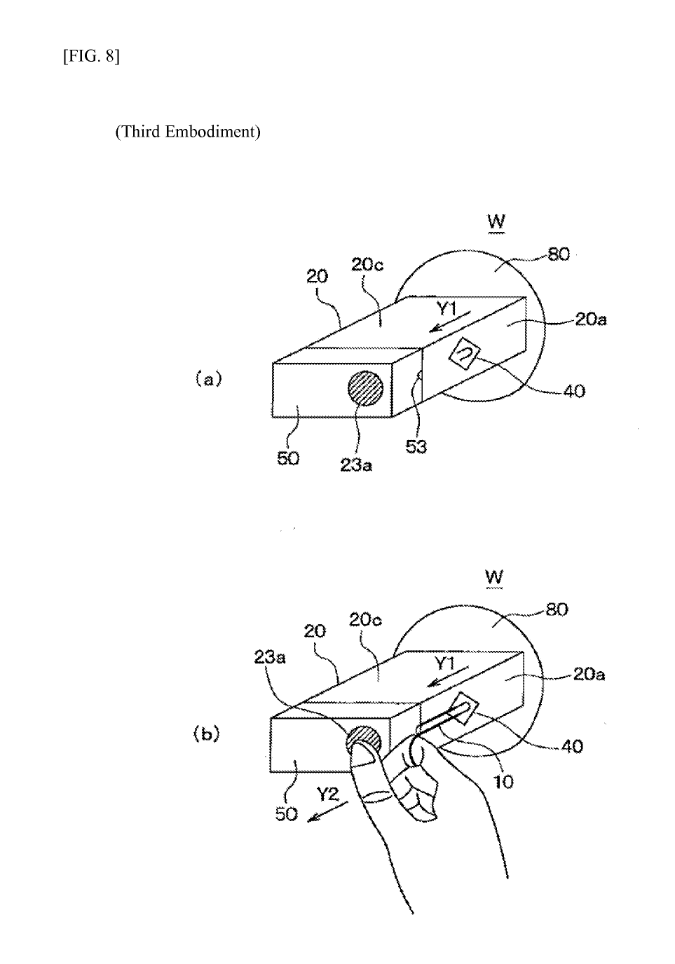

From an ergonomic and physiological perspective, the least stressful way to hold and grip an object may be the so-called “side grip” with the dorsum (back) of the hand facing outward or laterally (with the forearm neither in a supination nor a pronation position). By holding and gripping an object in this manner, a “lateral cubital position,” or in other words, a neutral position in which the elbow is facing outward, may be created. Specifically, a lateral cubital position is created when an object is held and gripped with the elbow and dorsum of the hand facing outward (away from the body), and as a result, burden on the shoulder and elbow may be reduced, thereby enabling delicate movement of the fingers. With the present embodiment that gives consideration to this point, cutter 40 is attached to side surface 20a, and therefore the floss string can be gripped and hung on cutter 40 with a side grip state in which the hand may be more stabilized, and the operation of cutting the floss string may be more easily facilitated. Incidentally, FIG. 5 and FIG. 8 are examples showing cutting of the floss string with the hand in a side grip state. Furthermore, because the cutter is attached to side surface 20a, the user may place, for example, her thumb on back surface 20b, front surface 20c, the corner between side surface 20a and front surface 20c, or the like, as she pleases, to create a pivot (i.e. supporting point) for smoothly hanging the floss string. This method of placing, for example, a finger on a surface thereof results in simplifying the operation of cutting the floss string for, for example, children or others who tend to have unsteady fingertips. The above-described “side grip” is explained below in greater detail. When a user is hanging the floss on cutter 40, if the distance between the fingertips holding the floss and cutter 40 is not short enough such that contact is almost immediately made with the cutter (distance thereof is called the shortest distance), the floss may not be skillfully hung on cutter 40. As described above, burden is minimized and delicate finger movement (i.e. maneuvering) may be more easily achieved with a side grip. If cutter 40 is not installed on side surface 20a, minimizing the distance between the fingertips and cutter 40 to the shortest possible distance and hanging the floss cannot be accomplished in a side grip state.

For example, if cutter 40 is installed in the center or middle of front surface 20c, in order to hang the floss on cutter 40, the shortest distance is achieved by gripping the floss with, for example, the fingertips and hanging it with, for example, the arm in an “over-gripped state” (that is, palm of the hand toward the ground). When a side grip is used with cutter 40 installed in this state, the hand and the fingers themselves come in contact with case 20 and may interfere with the floss hanging process. In addition, a so-called “shortest distance” at which the fingertips holding the floss come in contact almost immediately with cutter 40 cannot be created. Moreover, if cutter 40 is installed on top surface 20d or back surface 20b, a side grip may be possible, but the wall can become a hindrance, and case 20 itself may obstruct visibility, and therefore these surfaces may not be optimum surfaces for installation thereof. In addition, if cutter 40 is installed on inner lid 30, the index finger itself may become an obstruction when the floss is gripped with a side grip, and the floss cannot be skillfully hung on cutter 40.

In contrast, according to the present embodiment, cutter 40 is installed on side surface 20a at a position that is separated 1.5 cm from the wall (or, on front surface 20c at a position separated 1.5 cm from the wall near side surface 20a), and as shown in FIG. 5 (d), the configuration thereof may lead to a reduction in rotational moment when the floss is cut. Cutter 40 is preferably installed at a position on a side closer to the wall than the center position of the longitudinal direction of the case. However, if cutter 40 is installed at a position close to the wall, the wall itself may become an obstruction, making it, for example, difficult to hang the floss on cutter 40.

The above-described first embodiment assumes that floss is cut while case 20 (pressed part 20e) is pressed against wall surface W by, for example, a thumb. In contrast, this embodiment assumes that floss is cut while case 20 is pressed against wall surface W via suction cup 80. As shown in FIG. 8 (a), with the present embodiment, indicator part 23a is provided on outer lid 50 to promote the user to press against the case with, for example, a finger. If indicator part 23a thereof is pressed with, for example, a finger, as shown in FIG. 8 (b), case 20 is pressed against wall surface W via suction cup 80 without rotating. Indicator part 23a may, for example, be a printed indicator, an indicator formed as an irregular surface portion in case 20, or an indicator formed by attaching a separate material to case 20. Note that if a design without outer lid 50 is adopted for case 20, indicator part 23a may be provided on case 20. From the above, according to the present embodiment, a user may be prompted to press indicator part 23a with, for example, her thumb of the hand gripping the floss, and if floss 10 is pulled with indicator part 23a pressed in this manner, case 20 may be stabilized, floss 10 may be cut with a single hand, and the ergonomics of severing the floss may be enhanced. With the present embodiment, when lid 50 is open, the ability to hang the floss with the case in a stable state by adding the application of the thumb to inner lid 30 is achieved only when the cutter is installed on side surface 20a.

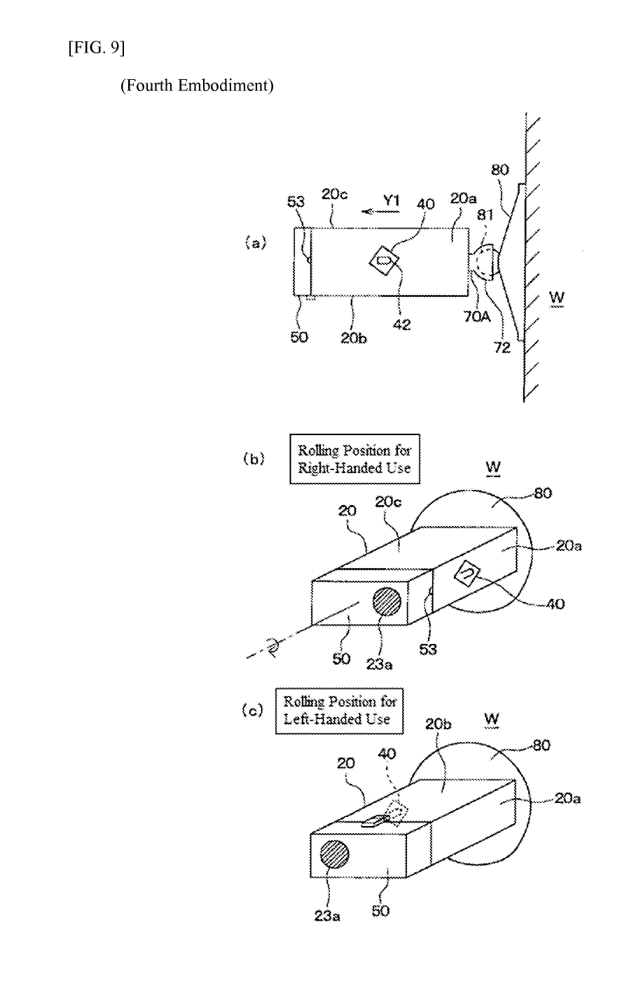

Mounting part 70, according to the above-described embodiment has one rotating shaft 71, and therefore has a function to adjust the pitch angle of case 20. In other words, mounting part 70 has a revolute pair configuration with a degree of freedom of one. It can be appreciated by one with ordinary skill in the field of mechanics, the term “degree of freedom” is the number of movable variables that determine the structure of an overall mechanism. In contrast, mounting part 70A of the present embodiment shown in FIG. 9 (a) has a function of adjusting a rolling angle as well as the pitch angle. The “rolling angle” is an angle of rotation around a center of rotation (see the dashed and dotted line in FIG. 9 (b)) extending in the vertical direction relative to wall surface W with suction cup 80 in a state of being suctioned to wall surface W. More specifically, sphere 81 provided on suction cup 80 and retention part 72 provided on mounting part 70A are caused to be fitted together. In other words, the structure is a spherical pair structure with a degree of freedom of three. Note that in place of this type of spherical pair structure, for example, a structure may also be adopted having a rotating shaft for adjusting the pitch angle and a rotating shaft for adjusting the rolling angle (in other words, a structure that combines two revolute pairs with a degree of freedom of one each). The material of mounting part 70A and sphere 81 may, for example, be either a synthetic resin or silicone or may be a combination thereof. Basically, sphere 81 (male type) that is connected with suction cup 80 part may be made of the same silicone material as suction cup 80, and mounting part 70A (female type) may be made of the same synthetic resin as case 20. Moreover, a design in which suction cup 80 is the female part and mounting part 70A is the male part may also be adopted. Accordingly, because the pitch angle can be adjusted, as described above, it may be adjusted according to the user's preference when floss is pulled out and when the floss is cut, and when the floss is not in use, case 20 may be stored away in a compact form so that it does not become an obstruction. Moreover, when the device is used by a right-handed person, the rolling angle may be adjusted such that cutter 40 is positioned on the right side as shown in FIG. 9 (b), and when used by a left-handed person, the rolling angle may be adjusted such that cutter 40 is positioned on the left side as shown in FIG. 9 (c). Hence, when, for example, both a right-handed user and a left-handed user are sharing a single interdental cleaning device, cutter 40 may be positioned in a direction that simplifies the cutting operation without having to remove suction cup 80 from wall surface W.

The present invention is not limited to the details described for the above embodiments, and the following types of changes may be implemented. Moreover, the characteristic configurations of each of the embodiments may be respectively and arbitrarily combined.

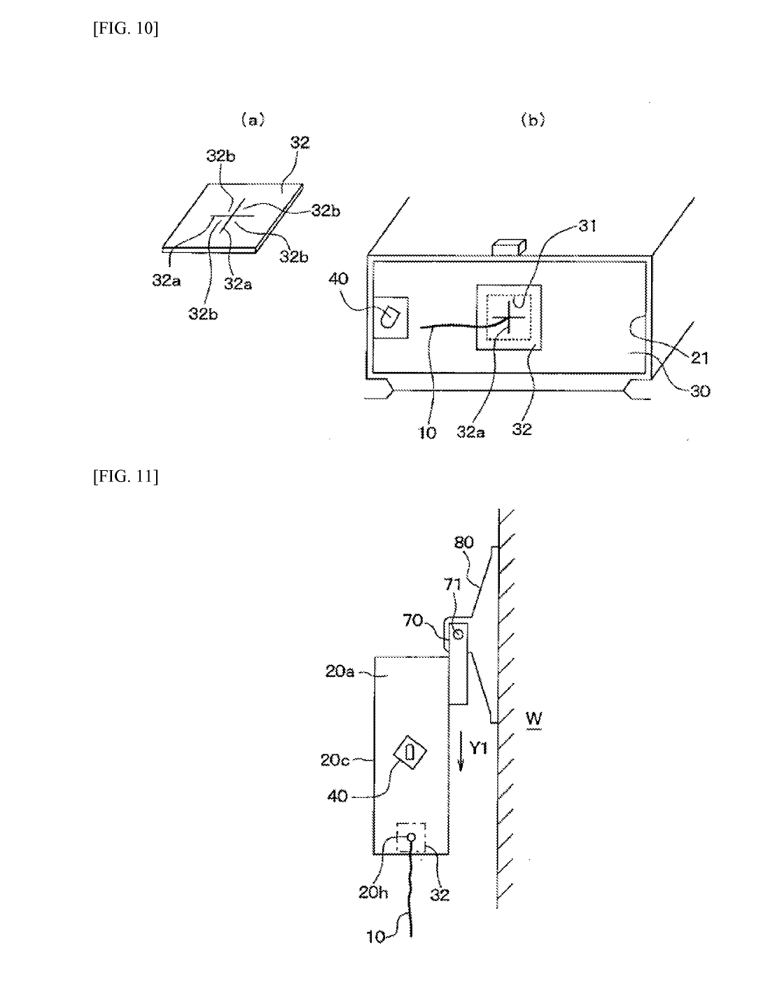

Extraction slot 31 of inner lid 30 shown in FIGS. 1 and 4 is preferably covered by a sheet 32 shown in FIG. 10 (a). Through this, penetration of water into case 20 from extraction slot 31 may be inhibited. In this configuration, if slit 32a is formed in sheet 32 such that floss 10 is pulled out from slit 32a, peripheral portions 32b of slit 32a in sheet 32 undergo elastic deformation and remain in close contact with floss 10. Therefore, penetration of water into case 20 from slit 32a of sheet 32 may be further inhibited.

In FIGS. 1 and 4, a double layer structure having inner lid 30 and outer lid 50 is formed, but outer lid 50 may also, in some embodiments, be eliminated. Of course, if outer lid 50 is eliminated, as shown in FIG. 11, sheet 32 (see FIG. 10) may be preferably applied to extraction hole 20h through which floss 10 is pulled out in order to inhibit the penetration of water into case 20 from extraction hole 20h. In the above-described embodiment, cutters 40 are installed on both side surfaces 20a, thereby providing enhanced ergonomics in severing the floss while accommodating needs for both a right-handed user and a left-handed user, but cutter 40 may be attached to just one of side surfaces 20a in order to reduce costs. Note that even if cutter 40 is attached to only one side, if the direction of case 20 when suction cup 80 is suctioned to the wall surface is changed 180 degrees, adequate ergonomics for severing the floss may be achieved for either a right-handed user or a left-handed user. Of course, if multiple users share a single interproximal cleaning device, attachment of cutter 40 to both sides may provide enhanced floss cutting ergonomics for both a right-handed user and a left-handed user without having to change the direction of case 20. However, if holding projection 60 is provided, cutter 40 is preferably located at a position that does not interfere with holding projection 60.

The above-described embodiments may be combined such that cutter 40 is attached to both the inside and the outside of outer lid 50. Through this configuration, any of the cutting methods of FIGS. 2, 5, and 7 may be adopted. Moreover, in the above embodiment, outer lid 50 may also be eliminated. Put simply, in the above embodiment, cutter 40 may be exposed on the outside of case 20.

In the above-described embodiment, guide groove 53 is formed in outer lid 50, but the groove thereof may also be formed in case 20, and may be formed extending into both case 20 and outer lid 50.

In the above-described embodiment, guide groove 53 is formed at a place in outer lid 50 adjacent to side surface 20a, but guide groove 53 may also be formed at a place in outer lid 50 adjacent to back surface 20b. Or, the guide groove may be eliminated and the floss pulled out from a gap between outer lid 50 and case 20.

In the above-described embodiment, cutter 40 is attached to side surface 20a, but it may also be attached to back surface 20b or front surface 20c.

In each of the above-described embodiments, by positioning rotating shaft 71 further upward than top surface 20d when the device is in the stored away state, the device is configured such that the pitch angle becomes 90 degrees or greater, but rotating shaft 71 may also be positioned further downward than top surface 20d. Moreover, instead of attaching mounting part 70 to back surface 20b of the case, it may be attached to side surface 20a, top surface 20d, or front surface 20c.

Protective sheet 43 according to the above-described embodiment is also preferably attached to cutter 40 according to the above embodiments.

Cutter 40 formed by cutting and raising a portion of metal plate 41 as shown in FIG. 6 functions such that floss 10 is severed at the base part of the cut and raised portion. Therefore, protective sheet 43 is preferably attached in a range excluding the base part thereof. Moreover, in order to cover the edge of the cut and raised portion, protective sheet 43 is preferably larger than the cut and raised portion.

The holding means according to the above-described first embodiment is formed in a projecting shape that protrudes from case 20, but a hole (i.e. space) in which used floss 10 may be inserted and temporarily held may be provided in case 20, and this hole (i.e. space) may be used as a holding means. Or, a net formed in the shape of a bag may be provided on case 20, and the net thereof may be used as a holding means. Also, as shown in the application examples of FIGS. 12 and 13, projections for hanging used floss may be provided in the form of, for example, a head, limbs, or tail of an animal character, or the like, and used floss storage space may be provided in portions corresponding to, for example, the torso of an animal.

If case 20 is designed to exhibit a high level of water-tightness (i.e. water resistance) such that water does not penetrate the inside of case 20, drainage hole 51 may be eliminated to avoid the risk of water penetrating from drainage hole 51.

Extraction slot 31 shown in FIG. 1 is designed sufficiently larger than the diameter dimension of floss 10, but the slot thereof may be shaped with a diameter dimension that is the same as the diameter dimension of the floss to inhibit penetration of water to the inside of case 20 from extraction slot 31.

With each of the above-described embodiments, case 20 is formed in a rectangular parallelepiped shape, but case 20 according to the present embodiment is not limited to this type of shape, and for example, may be a cylindrical shape or a spherical shape. Moreover, each of the surfaces of a rectangular parallelepiped shape may also be formed as curved surface shapes.

As a means to secure cutter 40 to case 20, cutter 40 may be adhered to case 20 by an adhesive, or a mating part may be formed in case 20, and cutter 40 then inserted and secured in the mating part thereof.

In the example shown in FIG. 3, indicator part 23 is provided on back surface 20b of case 20, but the indicator part may also be provided at the position shown by the dashed and dotted line 23b in FIG. 3 (c). In other words, indicator part 23 may be provided extending to both back surface 20b and side surface 20a positioned on the side further from cutter 40.

1. An interdental cleaning device comprising:
floss for removing food debris,
a case for housing the floss, the case including a back surface, and an inner lid with an extraction slot extending therethrough enabling the floss to be pulled from the case at a floss pulling direction;
a cutter attached to the case for severing the floss to a desired length,
a suction cup attached to the case for suctioning to a wall surface of a location in which the floss is used; and
a mounting part pivotally mounting the case to the suction cup, whereby the case is capable of rotating from a storage position with the back surface facing the wall surface to a use position at a desired pitch angle with the floss pulling direction directed towards a user to facilitate removal of floss from the extraction slot.

2. The interdental cleaning device according to claim 1,
wherein friction in the mounting part prevents the case from rotating under its own weight providing stability for the case in the use position during floss extraction.

3. The interdental cleaning device according to claim 1, wherein the cutter is positioned on a side of the case, whereby in the use position floss is cut by pulling on the floss hung on the cutter at an optimum cutting direction; and wherein the optimum cutting direction is a direction parallel to the floss pulling direction at the desired pitch angle.

4. The interdental cleaning device according to claim 1, wherein the inner lid is at the bottom of the case in the storage position, whereby water drains out of the extraction slot when not in use.

5. (canceled)

6. The interdental cleaning device according to claim 1, wherein the case includes a pressed part for pressing against the suction cup at a predetermined pitch angle; and
wherein the case is configured to rotate to a case pressing position, in which the pressed part of the case is pressed against the wall surface via the suction cup to provide a stable position for cutting the floss.

7. The interdental cleaning device according to claim 6, wherein the case includes an indicator part to denote a position at which a part of the case is to be pressed by the user's finger in the case pressing position.

8. The interdental cleaning device according to claim 1, wherein the case includes an indicator part to indicate a position at which the user of the floss presses against the case with a finger, to provide a stable position for cutting the floss.

9. The interdental cleaning device according to claim 1, wherein the mounting part comprises a male part and a female part configured to provide adjustment of both the pitch angle and a rolling angle of the case with respect to the wall surface.

10. The interdental cleaning device according to claim 1,
wherein the cutter is attached to an the exterior surface of the inner lid part.

11. The interdental cleaning device according to claim 1, wherein the cutter comprises:
a metal plate having spaced longitudinal raised edges thereof providing cutting surfaces, which are formed and adapted to sever floss; and
a protective member attached to the cutting surfaces.

12. The interdental cleaning device according to claim 3, wherein a mounting position for the cutter with respect to the case is set such that a distance from the wall surface to the cutter is between 1.5 cm to a center position of the side of the case.

13. The interdental cleaning device according to claim 1, wherein the case further comprises an outer lid to cover the extraction slot, and
a guide groove provided in at least one of the case or the outer lid to guide the floss during extraction.

14. The interdental cleaning device according to claim 13, wherein the outer lid includes a drainage hole for draining water from inside the case when in the storage position.

15. The interdental cleaning device according to claim 1, wherein the case further comprises: a projection extending from a side thereof to retain or store used floss.

16. The interdental cleaning device according to claim 1, wherein the desired pitch angle is between 45° to 135° from the storage position.

17. The interdental cleaning device according to claim 1, wherein the desired pitch angle is about 90° from the storage position.

18. The interdental cleaning device according to claim 6, wherein the pitch angle in the case pressing position is between 125° to 145° from the storage position.
